(19) United States
(12) Patent Application Publication
(10) Pub. No.: US 2010/0050509 A1
(43) Pub. Date: Mar. 4, 2010

(54) Fabric roof planter

(76) Inventors: Kelly W. Luckett, Florissant, MO (US); John V. Jost, Des Peres, MO (US)

Correspondence Address: POLSTER, LIEDER, WOODRUFF & LUCCHESI, 12412 POWERSCOURT DRIVE SUITE 200, ST. LOUIS, MO, 63131-3615, US

(21) Appl. No.: 12/462,063

(22) Filed: Jul. 28, 2009

Related U.S. Application Data
(63) Continuation-in-part of application No. 11/357,609, filed on Feb. 17, 2006, now abandoned.

(51) Int. Cl. A01G 9/02

(52) U.S. Cl. 47/65.9; 47/66.7

(57) ABSTRACT

A roof planter comprising growth media capable of sustaining a desired vegetation, a sack retaining a quantity of the growth media, the sack being formed of moisture permeable material that is capable of retaining the growth media, the sack having an opening capable of accepting the growth media, and a pad in association with the sack and capable of separating the sack from the top of a roof. When the desired vegetation is planted in the growth media being retained by the sack, and the pad is positioned between the sack and the roof, the vegetation may grow in the sack on the roof without causing damage to the roof. Further, a fabric roof planter is disclosed having a sack that is fashioned with vertical sidewalls to facilitate a predictable footprint; handles to facilitate horizontal transport; and sealable windows to facilitate the rapid planting of vegetation in the growth media retained by the sack.

### CROSS REFERENCE TO RELATED APPLICATIONS

This application is a continuation-in-part of U.S. application Ser. No. 11/357,609, filed Feb. 17, 2006, for the invention of Kelly William Luckeft and Victor Jost entitled “Fabric Roof Planter,” and derives and claims priority from that application, which application Ser. No. 11/357,609 is fully incorporated by reference herein.

### STATEMENT REGARDING FEDERALLY SPONSORED RESEARCH OR DEVELOPMENT

Not Applicable.

### BACKGROUND OF THE INVENTION

Green roofs, roof gardens, eco-roofs all refer to the planting of vegetation on the roof surface of building structures. The principle of green roofs has been widely used in Europe for several decades. Roof top vegetation substantially reduces storm water run off, solar heat gain, and thermal transfer through the roof. In addition, large vegetated surfaces help to replenish oxygen through photosynthesis. Though the benefits are many, the typical green roof costs are several times that of most roofing systems. The high price of typical green roof construction emanates from costly waterproofing procedures, extensive drainage layers, soil of depths ranging from eight inches to twenty four inches, and additional required structural construction to support resulting increased weight. Repairs to the roofing membrane are extremely expensive due to the large quantities of material that must be moved to access the waterproofing layer.

Roof planters have recently been developed that can be placed atop standard roofs without the need for special roof construction. These include modular and full system planters in which the plants are housed in rigid containers atop the roof. However, these planters still have cost disadvantages. In particular, the material handling aspect of green roof installation continues to be problematic. Large amounts of soil (also known as “growth media”) are needed for plant growth on rooftops. Transporting the required soil from the source to the project rooftop is difficult and expensive. While pre-planted module planters are a significant improvement over previous methods of green roof installation, they are heavy and the cost of such module planters presents a barrier that many projects are unable to overcome. Moreover, it is desirable that planters installed on a roof be movable in order to provide access to the roof under the planters for inspection and maintenance of the roof. Hence, a more mobile and cost-effective planter is desirable. In addition, there is resistance to using green roof systems due to the need for installation methods that vary substantially from techniques and methods traditionally used in the roofing industry. Hence, it is desirable to have a roof planter that can be installed by more traditional methods commonly used in the roofing industry.

In addition, each roofing manufacturer markets and sells roofing material of differing compositions, and each manufacturer offers warranties on its new roofing material. During construction of a roof, it is often desirable and/or necessary for the laborers to tread upon newly laid roofing. To minimize trauma to the newly laid roofing and to prevent the voiding of warranties on the newly laid roofing, each manufacturer markets and sells walk pad material that can be placed upon the newly laid roofing to allow laborers to walk atop the newly laid roofing with minimal damage and without voiding the roofing manufacturer's warranties. Each roofing manufacturer's walk pad is composed of material specifically engineered for use on that same manufacturer's roofing material. The use of any other walk pad or any other material on the roof risks damage to the roofing material and voiding of the manufacturer's warranty. This can present yet another major obstacle to the acceptability of green roof systems.

### BRIEF DESCRIPTION OF THE SEVERAL VIEWS OF THE DRAWINGS

The illustrative embodiments of the present invention are shown in the following drawings that form a part of the specification:

FIG. 1 is a perspective view of an embodiment of the fabric roof planter, the fabric roof planter setting on a pad atop a roof surface;

FIG. 2 is a macro view of the material used to construct an embodiment of the fabric roof planter;

FIG. 3 is a perspective view of a portion of the top of an embodiment of the fabric roof planter showing a cross-shaped slit having plants rooted in growth media of the planter;

FIG. 4 is a perspective view of a pallet upon which are stacked multiple fabric roof planters having the embodiment;

FIG. 5 is a perspective view of the sack of the first embodiment of the fabric roof planter, wherein the sack is shown open at one end;

FIG. 6 is a perspective view of multiple fabric roof planters stacked atop a pallet;

FIG. 7 is a perspective view of an alternate embodiment of the fabric roof planter having a generally rectangular shape, a sealable window for the placement of vegetation in the planter, and handles, the planter window being shown in an open position;

FIG. 8 is a perspective view of yet another alternate embodiment of the fabric roof planter having a generally rectangular shape, a plurality of sealable windows for the placement of vegetation in the planter, and handles, the planter being shown with some of the windows open and some closed;

FIG. 9 is a perspective view of an embodiment of the fabric roof planter having handles at each end and being carried by the handles by two persons;

FIG. 10 is a perspective view of a plurality of fabric roof planters of an embodiment having a generally rectangular shape, where the planters are placed flat upon a surface in a close-packed configuration;

Corresponding reference characters indicate corresponding parts throughout the several views of the drawings.

### DETAILED DESCRIPTION OF INVENTION

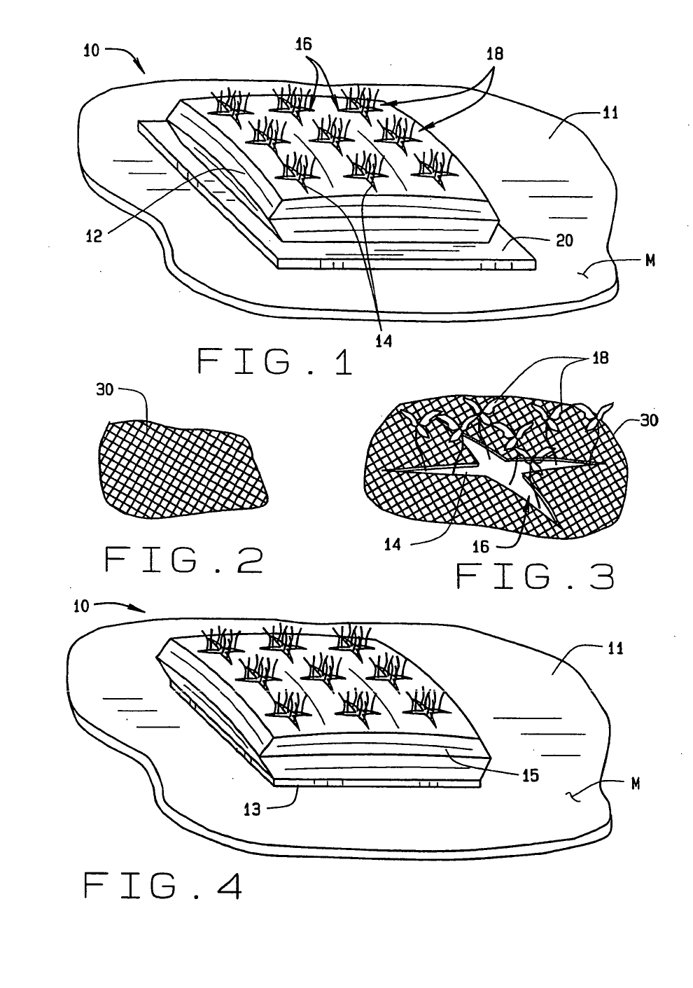

In an illustrative embodiment (FIG. 1), the fabric roof planter 10 is shown positioned on a roof upper surface 11. The planter 10 comprises a fiber sack 12, nine slits 14 in the sack 12, growth media 16 retained in the sack 12, and a protective pad 20 positioned between the sack 12 and the roof surface 11. The roof surface 11 comprises a membrane M atop the surface 11. The surface 11 may be of virtually any profile, including for example, flat, pitched, curved or otherwise uneven. The sack 12 is formed of a moisture permeable material, preferably a high durability plastic fiber, and even more preferably knitted high density polyethylene 30 (see FIG. 2), with a weave that is tight enough to retain the growth media 16 in the sack 12 while allowing moisture to pass through the sack 12. This construction also keeps sharp particles from spilling out of the sack 12 onto the roof surface 11 and into roof drainage systems. As shown in FIGS. 1 and 3, the vegetation 18 is planted in the growth media 16 through the slits 14 in the sack 12. The slits 14 may be preformed in the sack 12, prior to filling with the growth media 16, or the slits 14 may be cut into the sack 12 at any time thereafter to accommodate planting the vegetation 18 in the planter 10.

The pad 20 (FIG. 1) is formed of a material that is compatible with the roof surface 11 and intended to provide a buffer between the sack 12 and the surface of the roof 11 to protect the roof membrane M. Accordingly, the pad 20 may be composed of a variety of materials, including for example: roof walk pad material; roof shingle material; rubber; roof paper; plastic; foam; wood; cloth; and geo-textile. Preferably, the pad 20 is formed of a geo-textile material that is known to be compatible with most roof membrane materials. The pad 20 is therefore positioned between the sack 12 and the upper surface of the roof 11 such that the sack 12 does not substantially contact the surface 11. The pad 20 may alternatively be attached to the sack 12, or may form a portion of the sack 12 (see FIG. 4). In such a configuration, the pad portion 13 of the sack 15 forms the primary contact between the planter 10 and the surface of the roof 11. Of course, one of ordinary skill in the art will recognize that a protective pad 20 may not be required for all applications, and that the planter 10 may be configured without the pad 20.

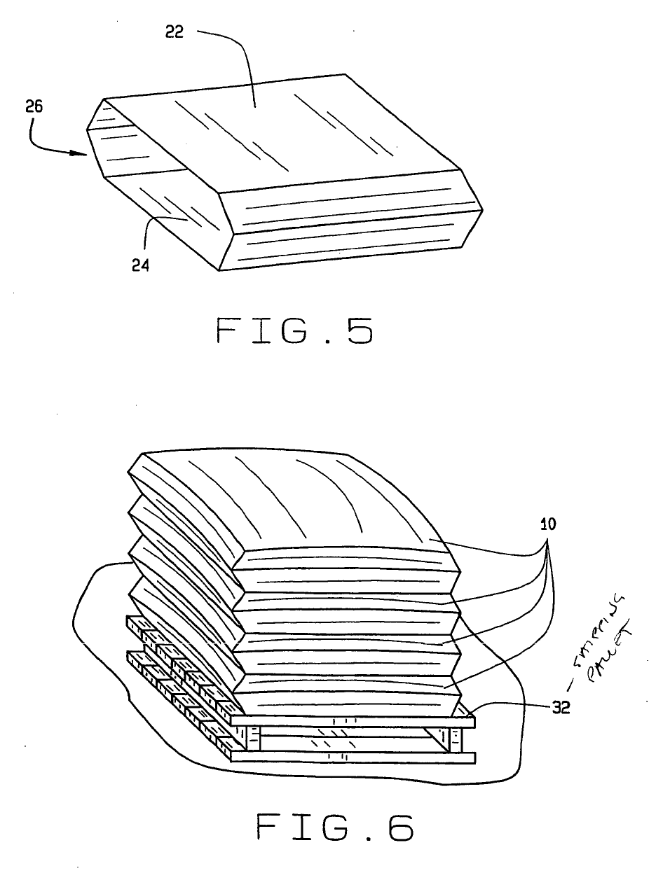

The sack 12 of FIG. 1 is formed by sealing two generally rectangular shaped sheets 22, 24 (FIG. 5) of moisture permeable material together along each of three sides of said sheets, thereby forming a pocket between the sheets 22,24 that is capable of retaining the growth media 16. The sheets 22,24 may be sealed together in a number of ways well understood by one of ordinary skill in the art, including but not limited to sewing, heat sealing, gluing and clamping. The remaining fourth sides of each of the sheets 22, 24 define an opening 26 in the sack 12. The growth media 16 is placed in the sack 12 through the opening 26. The opening 26 is then also sealed shut, which may also be accomplished in a number ways well understood by one of ordinary skill in the art, including, for example, tying, sewing, heat sealing, gluing and clamping.

The sack 12 is formed of a fabric 30 as depicted in FIG. 2. The fabric 30 is constructed of a weave that is capable of retaining the desired growth media 16 while being moisture permeable. The fabric 30 is preferably constructed of nylon material, and even more preferably a knitted high density polyethylene. Of course, the fabric 30 that forms the sack 12 may be of differing configurations and formed of different materials depending on the specific formulation of growth media 16 that will be placed in the sack 12. That is, the smaller the granulation of the desired growth media 16 to be placed in the sack 12, the tighter the weave that is required in the fiber 30. Conversely, the larger the granulation of the desired growth media 16 to be placed in the sack 12, the more relaxed can be the weave in the fiber 30. Moreover, the sack 12 can alternatively be constructed, at least in part, of a non-porous material, such as for example plastic (not shown), if the sack 12 has holes, slits or other such openings in the material that are sized and/or positioned on the sack 12 such that they are capable of retaining the growth media 16 while allowing for the penetration of moisture.

The sack 12 of the present embodiment of the planter 10 as shown in FIGS. 1, 2 and 5, is constructed of two sheets 22,24 of fabric 30 where three sides of each of the sheets are sewn together. Of course, the sack 12 could be constructed in alternate ways. For example, the fabric 30 could be produced in the shape of a tube and thereby only require one end to initially be sealed or sewn together to form the sack 12. In any event, once the sack 12 is formed, the user has a number of options in application of the planter 10 upon a roof surface 11.

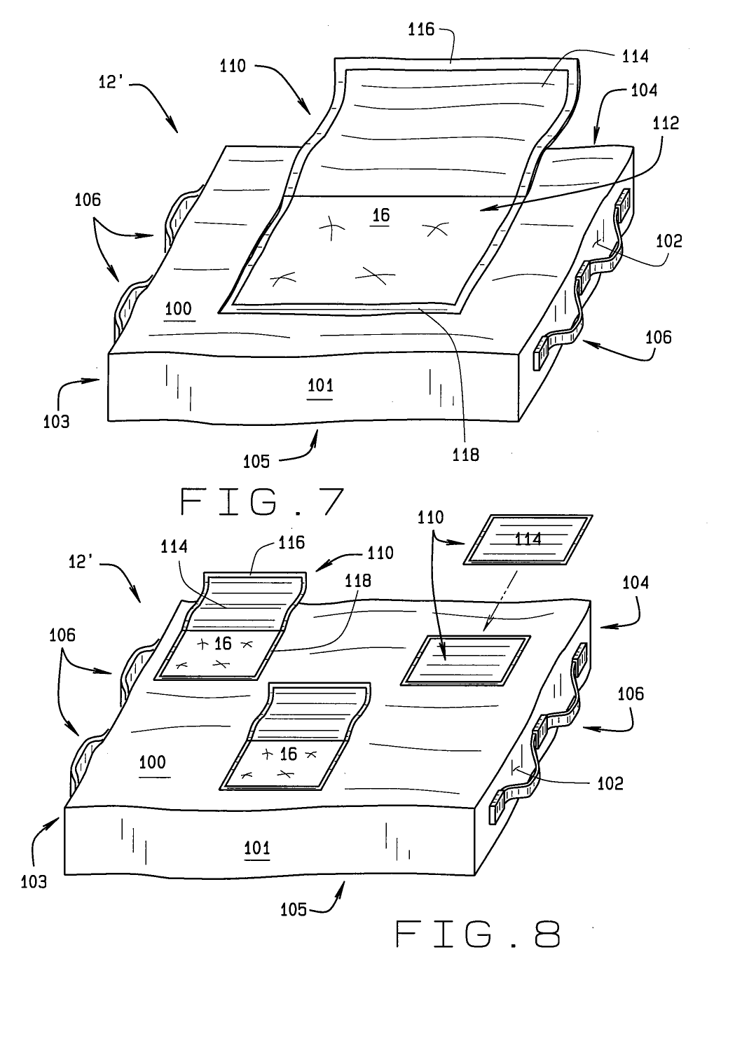

The sack 12 may be shaped in a variety of configurations in all three dimensions, taking for example the shape of a box, a tube, or a cup. Hence, the roof planter 10 may be a shape other than rectangular or square, such as, round, oval, triangular, or any other shape desired by the user. Significantly, a unique feature of the present disclosure is the fabrication of a fabric roof planter sack having vertical sidewalls or surfaces. In most instances, a generally vertical edge will form where the edges of the sidewalls or surfaces meet. In one such embodiment, the sack 12′ is formed in a boxlike shape as depicted in FIGS. 7-10. Referring to FIG. 7, it can be seen that this embodiment of the sack has a generally rectangular upper surface 100 with preferred dimensions of 24 inches in width and 30 inches in length, four vertical and generally rectangular side surfaces 101, 102, 103 and 104, each having a preferred height of 4 inches, and a corresponding generally rectangular bottom surface 105 with preferred dimensions of 24 inches in width and 30 inches in length. Each of the surfaces 100-105 are shaped and configured in conjunction with the shape of the sack 12 to be generally flat when the sack 12 is filled with growth media 16. Of course, due to the flexible nature of the material comprising the sack 12′, the surfaces 100-105 will distort without some form of support such as when the sack 12′ is filled with growth media 16.

Although more costly and requiring custom fabrication, a fabric roof sack having vertical side walls, or more particularly, the boxlike shape of the sack 12′ provides a substantial advantage in roof planter applications over traditionally shaped sacks, which are generally tubular in shape. The roof coverage of the planters drives nearly all estimate and installation functions for a roof job, including designing, bidding, costing and installing roof planters. Due to the highly variable shape of traditional sacks when used as fabric planters, the coverage estimates are often inaccurate and can vary greatly on every job. For example, estimating fabric roof planter coverage using traditional sacks would require inputting ranges of 18 to 22 inches for the width of each sack and 28 to 32 inches for the length of each sack. This translates into a high risk of shortages and/or overages and the negative resulting costs and waste associated with such inaccuracies. Further, using traditional sacks, each job requires manipulation and manual placement and often replacement of sacks to arrive at a uniform and aesthetically pleasing arrangement of roof planters. In contrast, the boxlike shape of the sack 12′ provides a specific footprint for each sack 12′ and a resulting higher accuracy for all aspects of the job design, estimate and installation. Of course, the addition of even one such vertical sidewall or side surface (e.g. 101-104) to a fabric roof planter will provide an incremental improvement in the accuracy of the job design, estimate and installation.

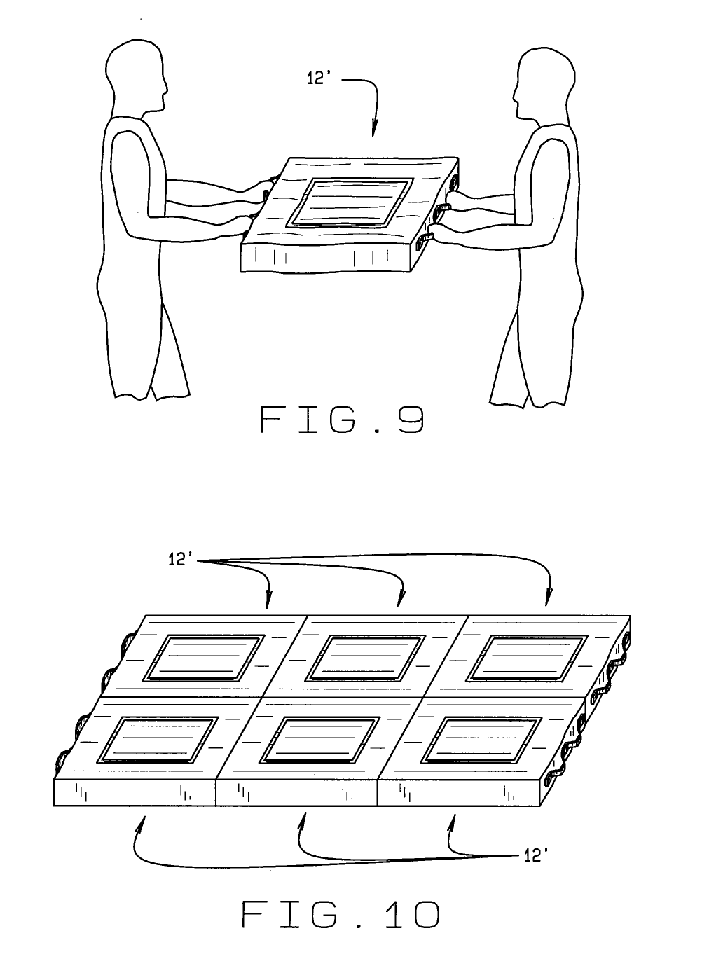

Further, the roof planter 10 may additionally incorporate features to aid in handling the planter, such as handles and grips. For instance, the sack 12 or the pad 20 may be shaped to incorporate handles, grips or grip holes, or such features may simply be attached to the roof planter 10. In this regard, the sack 12′ is constructed with a pair of carrying straps or handles 105 attached to each of two opposite side surfaces 102 and 103, as shown in FIGS. 7-8. The pairs of handles 105 are preferably constructed of the same material as the sack 12, 12′, but may be constructed of any variety of materials that can be attached to the opposite side surfaces 102 and 103 with sufficient strength to lift the sack 12′ when filled with growth media 16 without failure. Although formed of a single length of material sewn at each end and in the middle to the side surfaces 102 and 103, each of the individual handles in the pairs 105 can alternately be formed separately, so long as they are positioned outwardly from the center of the side surfaces 102 and 103. The individual handles in each pair of handles 105 are spaced apart from one another along the opposite side surfaces 102 and 103, such that when the sack 12′ is raised by the handles 105, the sack 12′ can be carried in a generally flat orientation as illustrated in FIG. 9. The handles 105 can also be alternately attached to the sack 12′ at different positions. For example, the handles 105 can be attached to the upper surface 100, the lower surface 104, the seam between the upper surface 100 and one or more of the side surfaces 101-104, or the seam between the lower surface 105 and one or more of the side surfaces 101-104.

This is significant in that when the sacks 12′ are filled with growth media 16, and then transported, handled and then placed or positioned on a roof, the growth media 16 can readily shift within the sack 12′ from one portion of the sack to another. This results in the undesirable conditions of uneven distribution of the growth media in the sack 12′. Uneven distribution of the growth media 16 in the sack 12′ leads to thin spots in the sack 12′ that present an unattractive surface of the sack 12′ when positioned on a roof, and can adversely impact the short and long-term growth potential of the vegetation planted in the growth media 16 due to variations across the media 16 in water retention capability, thermal insulation and nutrient availability. The handles 105 provide a desirable mechanism to enable persons handling the sacks 12′ to keep the sacks 12′ relatively horizontal during filling, stacking, storage, distribution and positioning on a roof, to thereby minimize the undesirable shifting of the growth media 16 within the sacks 12′. The handles also provide a surer grip to the sack 12′ and eliminates the need to wear gloves during handling of the sacks 12′, which gloves were highly desirable when handling roof planter sacks without any such handles 105.

The sack 12′ is further constructed with a sealable window 110. (FIG. 7). The window 110 comprises a generally rectangular opening 112 in the upper surface 100 of the sack 12′ and a closure 114 attached to one end of the opening 112. The closure 114 has the same general shape of the opening 112 to enable the closure 114 to seal against the opening 112 to close the sack 12′ to generally prevent inadvertent leaking of growth media 16 from the sack 12′ during activities such as shipping, handling or installation. While the opening 112 shown in FIG. 7 is generally rectangular, the opening can be of nearly any shape and size, and can be positioned at any location on the upper surface 100. In this version of the sealable window 110, strips of a good and loop materials such as Velcro® 116 are attached along the outwardly facing edges of the opening 112 that are not attached to the closure 114. Mating strips of Velcro® 118 are likewise attached to the inwardly facing outer edges of the closure 114 that are not attached to the opening 112. When the closure 114 is properly positioned in contact along the full perimeter of the opening 112, the Velcro® strips 116 of the closure 114 and the strips 118 of the opening 112 can engage each other and the closure 114 thereby fully shuts the opening 112. In this embodiment, the closure 114 is constructed of the same material as the sack 12′. However, various alternate materials could be used so long as the closure 114 is able to seal against the opening 112 to generally prevent the inadvertent leaking of growth media 16 from the sack 12′ as described herein.

The windows 110, formed during fabrication of the sack 12′, provide a significant improvement over sacks having no preformed sealable opening for the placement of vegetation. When using a sack 12 without a window 110, installation requires the creation of an opening on the roof. Generally, such openings can be formed with a razor or other such sharp tool, or with a directed flame such as from a small torch. The use of cutting tools and torches on a rooftop can be a dangerous activity. In addition, cutting through the fabric and into the growth media 16, which is typically highly abrasive, causes the cutting tools to dull very quickly, resulting in frequent changes or sharpening and a very slow process.

Of course, variations exist with respect to this inventive window 110. For example, the window 110 may be sealed with a variety of closure materials and mechanisms, such as for example, buttons, zippers, adhesives, snaps and ties. Further, strips of fabric, metal or other material may be interwoven along the edges of the window 110. In addition, for certain applications it may not be necessary to seal the entire perimeter of the window 110. For example, in some applications, it may only be necessary to seal the edge of the window 110 opposite the edge along which the opening 110 is attached to the closure 114, or, alternately, it may only be necessary to seal the edges extending from the opening 110 is attached to the closure 114. Moreover, it may be desirable to completely remove the closure 114 from the opening 112, in which case no portion of the closure 114 will be permanently attached to the opening 112. Rather, the closure 114 and the opening 112 will have mating Velcro® strips to enable the complete removal of the closure 114 from the opening 112, as shown in FIG. 8. While it is not a necessity that the window 110 be resealable once the vegetation 18 is placed in the sack 12′, it will be recognized that the use of a closure mechanism such as Velcro® provides the added benefit of multiple uses of the sealing attribute for the window 110.

The adaptive nature of the present disclosure provides a substantial improvement over existing roof planters. For example, the sack 12 may be filled with growth media 16 at any time that is most convenient to the user prior to planting the vegetation 18 in the growth media. It may be desirable to fill the sack 12 with growth media 16 at a manufacturing or processing facility and then transport the filled sack 12 and associated pads 20 to a job site where they will then be positioned on the upper surface of a roof 11. The vegetation 18 may be planted in the growth media 16 prior to, or after, the planter 10 is positioned on the roof 11. Alternatively, the sack 12 may be delivered to a job site empty, and the growth media 16 may be placed in the sack 12 at the site. Again, the vegetation 18 may be planted in the growth media 16 prior to, or after, the planter 10 is positioned on the roof 11. In yet another alternative, both the growth media 16 and the vegetation 18 can be added to the sack 12 after the sack 12 is positioned on the pad 20 on the surface of the roof 11.

Further, quantities of the sacks 12 can be transported in bulk prior to filling with the growth media 16, or alternatively, quantities of the sacks 12 can readily be transported after already being filled with growth media 16. In the latter case, the sacks 12 may be conveniently stacked in groups or even on a pallet 32 for ease of conventional transport. (see FIG. 6). In this way, the sacks 12 can be readily stacked on pallets in the same manor as soil suppliers currently handle other products. The pre-packed sacks 12 provide an attractive alternate to the cranes and hoisting equipment necessary to hoist dump truck loads of material to the rooftop as pallets of pre-packed sacks 12 can be delivered to loading docks and conveyed to the rooftop using freight elevators. By assimilating into the existing operational infrastructure of the soil suppliers in this manner, little additional set up costs are incurred using the present disclosure.

In contrast with conventional rigid roof planter systems, which can only be shipped in quantities that cover approximately 64 square feet per standard pallet, the pre-packed sacks 12 can be shipped in quantities that will cover approximately 218 square feet per standard pallet. This increased shipping capacity reduces transport costs at each phase of distribution; warehousing, shipping to the project, and loading to the rooftop. Additionally, this concept allows for pre-packed soil to be easily warehoused and stocked without consideration given to shipping and storage duration or weather conditions. Moreover, the flexible and durable nature of the sacks 12 also allows for convenient transport with a lower likelihood of damage as compared with conventional rigid roof planters.

Hence, the sack 12 may be transported, along with the growth media 16 and the vegetation 18 and the protective pad 20, to a desired job site. There, the sack 12 may be filled with the growth media 16 before or after placement of the sack 12 on the roof surface 11. Similarly, the slits 14 may be formed or cut into the sack 12 before or after placement of the sack 12 on the roof surface 11. In fact, the slits 14 can even be formed in the sack 12 during manufacture of the sack 12 or prior to transport. It then follows that the vegetation 18 may be placed in the growth media 16 prior to placement on the roof surface 11 or after the sack is placed on the roof surface 11, so long as the sack 12 has first been filled with the growth media 16, and the slits 14 have been formed or cut into the sack 12.

As can be appreciated, all these variations and options in formation and placement of the sack planter 10 on a roof surface 11 provide a great degree of flexibility to the installer or user. In addition, the sack planter 10 can be manufactured in nearly limitless variations of size, shape and material configuration. Hence, the shape, size and weight of the planter 10 can readily be altered either at the manufacturing facility or even at the job site to accommodate specific needs or even aesthetic or artistic expression on any given installation.

Further exhibiting the unique adaptive characteristics of the fabric planter 10, due to its pliant nature and the large contact area of relatively high friction materials, the sack planter 10 is remarkably stable when properly positioned on the roof surface 11. Yet, the roof planter 10 can readily be removed from its resting location to allow, for example, the repositioning of the planter 10, inspection or repair of the planter 10, or inspection or maintenance of the surface of the roof 11. In addition, due to their compliant and formable nature, multiple sacks 12 of the fabric planter can be positioned next to one another with minimal precision, and yet accomplish proper installation and placement. As a result, the positioning of multiple sacks 12 on the surface of a roof 11 can be accomplished in less time and with less difficulty than is required for the positioning of conventional roof planters. These benefits are in addition to the benefits of the fabric roof planter over conventional roof planters realized due to the ease with which the fabric roof planter can be transported.

As a further feature of the present disclosure, the roof planter 10 may be placed upon a suitable roof surface 11, where the roof surface 11 is covered at least in part by a surface membrane M of roofing material having a known surface composition. (FIG. 1). Again, the roof surface 11 may be of virtually any profile, including for example, flat, pitched, curved or otherwise uneven. The pad 20 can be constructed from walk pad material specifically chosen to be compatible with the roofing material M upon which the particular roof planter 10 will rest. Generally, a specific roofing material manufacturer will identify specific walk pad materials that can be used upon that manufacturer's roofing material without voiding the manufacturer's warranty. Such walk pads have properties that result in an acceptable level of chemical and physical wear to the manufacturer's roofing material. Typically, each roofing material manufacturer will offer walk pads for use on its own roofing products. In this embodiment, it is preferable that the pad 20 be constructed of a material that is certified, or at least recognized or otherwise approved, by specific roofing material manufacturers to be compatible with specific roofing materials.

For example, should the roof planter 10 be slated for placement atop a roof having Firestone Building Products (“Firestone’) roofing material, then the pad 20 for that specific application would be constructed of walk pad material produced by Firestone, or in the alternative, the pad 20 could be constructed of any other material specifically approved for such use by Firestone. Alternately, the pad 20 may be compatible if they are constructed of a material that imparts minimal chemical degradation or physical wear to the roofing material, even if the pad 20 is not recognized or certified by any roofing material manufacturer. Of course, it is also possible that in certain applications, the sack 12 itself may be compatible with the roof surface membrane M, so that no pad 20 is necessary for such applications.

Additional variations on the basic construction are also available. For example, the exact shape and size of the roof planter 10 can be varied to form larger or smaller roof planter configurations. The sack 12 may be thick or thin. The sack 12 of the roof planter 10 may be constructed of a variety of materials, including but not limited to fabric, woven knitted high density polyethylene, rubber, paper, plastic, foam and cloth, or any other suitable material that is moisture permeable while being capable of retaining the growth media 16. Each dimension of the roof planter 10, and thereby all of its components, may be of varying sizes.

Similarly, more than one pad 20 may be used for each sack 12, or more than one sack 12 may be placed on a single pad 20. The exact number of pads 20 used in each embodiment may vary. For instance, in some applications it may only be desirable to use a single pad 20, while in other applications, a larger number of pads 20 may be desirable. In still other applications, it may be desirable to place more than one sack 12 on a single pad 20, or to bridge one or more sacks 12 across one or more pads 20. Further, the pad 20 may be formed of a single layer of material, or may be formed of two or more such layers. Hence, the number of pads 20 used may vary from a single pad to as many as the user may deem appropriate for the specific application. Further, the pads 20 may be attached to either the roof surface 11 or to the sack 12, and this attachment may be accomplished by a number of methods, including for example, the use of adhesives, rivets, bolts, slides, hinges, and nails, as well as other methods that would be readily apparent to one of ordinary skill in the art. Alternately, the pad 20 may be attached to the sack 12 and the sack 12, with the attached pad 20, can then be set upon the roof surface 11. The pad 20 may also be formed in a variety of shapes, such as oval, round, hexagonal or polygonal. The pad 20 may be of uniform or non-uniform dimensions, including thickness. The pad 20 may be perforated, and may comprise surface features such as abrasions, pits, and extrusions.

Of course, one of ordinary skill in the art will recognize that structural members may be added to strategic positions on or in the roof planter 10 to allow the use of a variety of materials. In addition, drain holes may be added to the sack 12 or the pad 20 to regulate the moisture content of the roof planter 10. Such drain holes may be covered with mesh or other covering to help prevent the release of the growth medium 16 from the roof planter 10.

The number and configuration of the slits 14 can also be varied. Virtually any reasonable number of slits 14 may be formed or cut into the sack 12, so long as the vegetation 18 can be planted through the slits 14 and the slits 14 are not so numerous or positioned so that they materially degrade the functional integrity of the sack 12 nor the ability of the sack 12 to retain the growth media 16. In addition, the slits 14 may be formed in virtually any shape and size, such that the slits 14 may actually be openings and not slit-shaped at all, again so long as the vegetation 18 can be planted through the slits 14 (or openings) and the configurations do not materially degrade the functional integrity of the sack 12 nor the ability of the sack 12 to retain the growth media 16.

Further, the vegetation 18 may consist of virtually any plant or combination of different plants that may be selected by the user.

The detailed description above illustrates the invention by way of example and not by way of limitation. This description clearly enables one skilled in the art to make and use the invention, and describes several embodiments, adaptations, variations, alternatives and uses of the invention, including what I presently believe is the best mode of carrying out the invention. As various changes could be made in the above constructions without departing from the scope of the invention, it is intended that all matter contained in the above description or shown in the accompanying drawings shall be interpreted as illustrative and not in a limiting sense.

1. In combination with a building roof having a surface covered with a layer of water resistant material, a roof planter comprising:
a. growth media capable of sustaining a desired vegetation;
b. a sack comprising a moisture permeable material capable of retaining the growth media, the sack being configured to retain a quantity of the growth media, the sack being capable of placement on the surface of the roof; such that when said quantity of growth media is retained by the sack, and the desired vegetation is planted in the growth media retained by the sack, and the sack is positioned on the layer of water resistant material covering the surface of the roof, the planter provides an adaptable housing for the growth of the vegetation on the roof; and
c. a protective pad in association with the sack, the pad being disposed substantially flat on the layer of water resistant material with a first side of the flatly disposed pad in contact with the layer of water resistant material and the sack disposed on an opposing second side of the flatly disposed pad, the pad providing a substantially flat protective layer between the sack and the layer of water resistant material covering the surface of roof;
wherein the pad comprises a material that is compatible with the layer of water resistant material covering the surface of the roof such that placing the planter on the roof does not materially degrade the integrity of the layer of water resistant material.

2. The combination of claim 1, wherein the desired vegetation is planted in the growth media after positioning of the sack on the roof.

3. The combination of claim 1, wherein the desired vegetation is planted in the growth media prior to positioning of the sack on the roof.

4. The combination of claim 1, wherein the sack comprises an opening, the opening being capable of providing access to the growth media for the planting of the desired vegetation in the planter.

5. The combination of claim 1, wherein the pad material comprises one or more of the following:
roof walk pad material;
roof shingle material;
rubber;
roof paper;
plastic;
foam;
wood;
cloth; and
geo-textile.

6. The combination of claim 1, wherein the sack material comprises one or more of the following:
fabric;
woven knitted high density polyethylene;
rubber;
paper;
plastic;
foam; and
cloth.

7. A method comprising:
a. selecting vegetation for growth on a building roof;
b. selecting growth media capable of sustaining the vegetation;
c. creating a sack capable of placement upon a roof, the sack being moisture permeable while also being capable of retaining the growth media;
d. placing a quantity of the growth media in the sack;
e. placing the vegetation in the growth media; and
f. disposing a protective pad substantially flat on a layer of water resistant material covering a surface of the roof with a first side of the flatly disposed pad in contact with the layer of water resistant material and placing the sack on an opposing second side of the flatly disposed pad, wherein the pad comprises a material that is compatible with the layer of water resistant material covering the surface of the roof such that placing the sack on the roof does not materially degrade the integrity of the layer of water resistant material.

8. The method of claim 7, wherein the pad comprises one or more of the materials selected from the group comprising:
roof walk pad material;
roof shingle material;
rubber;
roof paper;
plastic;
foam;
wood;
cloth; and
geo-textile.

9. The method of claim 7, further comprising forming an opening in the sack, the opening being capable of providing access to the growth media for the placing of the vegetation in the growth media through the sack.

10. The method of claim 9, wherein forming the opening occurs prior to placing the sack on the roof.

11. The method of claim 7, wherein placing the growth media in the sack occurs prior to placing the sack on the roof.

12. The method of claim 7, further comprising attaching the pad to the sack.

13. An adaptable building roof planter comprising:
a. growth media capable of sustaining a desired vegetation;
b. a sack formed of pliant moisture permeable material that is capable of retaining a quantity of the growth media, the sack being capable of positioning on a roof; and
c. a protective pad disposable in a substantially flat disposition between the sack and a layer of water resistant material covering the roof with a first side of the flatly disposed pad in contact with the water resistant material and an opposing second side of the flatly disposed pad in contact with the sack, the pad comprising a material that is compatible with the water resistant material covering the surface of the roof such that placing the sack on the roof does not materially degrade the integrity of the water resistant material;
wherein when said quantity of growth media is retained by the sack, and the desired vegetation is planted in the growth media retained by the sack, and the sack is positioned on the pad flatly disposed on the water resistant material covering the surface of the roof, the vegetation may grow in the sack on the roof without causing damage to the water resistant material.

14. The roof planter of claim 13, wherein the pad is attached to the sack.

15. The roof planter of claim 13, wherein the pad forms a portion of the sack such that the sack is capable of placement on the roof with only the pad contacting the roof.

16. The roof planter of claim 13, further comprising an opening capable of providing access to the growth media for the planting of the desired vegetation in the planter.

17. A fabric roof planter comprising a sack capable of being disposed on a roof, the sack being formed of pliant moisture permeable material that is capable of retaining a quantity of growth media, the growth media being capable of sustaining a desired vegetation, wherein the sack comprises an upper surface, a lower surface and a plurality of side surfaces, the side surfaces being generally vertical when the sack is filled with growth media.

18. The fabric roof planter of claim 17, wherein the upper surface of the sack is polygonal in shape.

19. The fabric roof planter of claim 17, wherein the sack is boxlike in shape.

20. A fabric roof planter comprising a sack capable of being disposed on a roof, the sack having an upper surface and being formed of pliant moisture permeable material that is capable of retaining a quantity of growth media, the growth media being capable of sustaining a desired vegetation, wherein the sack comprises a sealable window on the upper surface of the sack, the window including a closure.

21. The fabric roof planter of claim 20, wherein the closure is removable.

22. The fabric roof planter of claim 20, wherein the sealable window is resealable.

23. The fabric roof planter of claim 22, further comprising a resealable hook and loop closure.

24. A fabric roof planter comprising a sack capable of being disposed on a roof, the sack being formed of pliant moisture permeable material that is capable of retaining a quantity of growth media, the growth media being capable of sustaining a desired vegetation, wherein the sack comprises a plurality of handles, the handles positioned on the sack to facilitate the transport of the planter in a generally horizontal orientation.

25. The fabric roof planter of claim 24, wherein the sack comprises two or more opposing side surfaces and the plurality of handles comprise two pairs of handles, each pair of handles positioned along one of said opposing side surfaces, and wherein the handles in each pair of handles are outwardly separated from one another along each said respective opposing end of the sack to thereby distribute support to the sack along each said end.
